(19) United States
(12) Patent Application Publication
(10) Pub. No.: US 2026/0258219 A1
(43) Pub. Date: Sep. 3, 2026

(54) POLYURETHANE FOAM DECOMPOSITION DEVICE AND POLYURETHANE FOAM DECOMPOSITION METHOD

(71) Applicant: INOAC CORPORATION, Nagoya-shi, Aichi (JP)

(72) Inventor: Tomotaka HARA, Anjo-shi, Aichi (JP)

(73) Assignee: INOAC CORPORATION, Nagoya-shi, Aichi (JP)

(21) Appl. No.: 18/993,348

(22) PCT Filed: Sep. 11, 2023
(86) PCT No.: PCT/JP2023/032970

§ 371 Date: Jan. 10, 2025

(30) Foreign Application Priority Data
Sep. 21, 2022 (JP) 2022-149955

(51) Int. Cl. C08J 11/12

(52) U.S. Cl. CPC C08J 11/12; C08J 2375/04

(57) ABSTRACT

A decomposition device (20) for decomposing a polyurethane foam (11) includes a container (30) for containing the polyurethane foam (11) and a decomposer (13), a pressing part (21) for pressing the polyurethane foam (11) in the container (30), and a heating part (23) for heating an inside of the container (30). The container (30) includes a retaining part (31) for retaining a liquid material (10) containing a decomposed material of the polyurethane foam (11) and the decomposer (13). The pressing part (21) is configured to press the polyurethane foam (11) downward to push the polyurethane foam (11) into the liquid material (10) in the retaining part (31).

### TECHNICAL FIELD

The present disclosure relates to a polyurethane foam decomposition device and a polyurethane foam decomposition method. This application is based on and claims the benefit of priority of Japanese Patent Application No. 2022-149955 filed on Sep. 21, 2022, the entire contents of which are incorporated herein by reference.

### BACKGROUND ART

Patent Literature 1 discloses a method for decomposing a hard urethane resin. This method includes a decomposition step of loading a hard urethane resin and an amine compound as a decomposer into an extruder and heating them to 140 to 300° C. to promote decomposition of a urethane bond of the hard urethane resin.

### CITATIONS LIST

### Patent Literature

Patent Literature 1: JP 2004-292661 A

### SUMMARY OF INVENTION

### Technical Problems

When the polyurethane foam and the decomposer are mixed, and the polyurethane foam is decomposed by using an extruder, it is difficult to control the mixed state of the polyurethane foam and the decomposer and to control the decomposition reaction. Thus, there is a problem that the quality of the resulting decomposed material is not stable, for example, undecomposed polyurethane foam is discharged from an extruder.

The present disclosure has been made in view of the above circumstances, and an object of the present disclosure is to provide a polyurethane foam decomposition method and a polyurethane foam decomposition device capable of obtaining a polyol having stable quality. The present disclosure can be implemented in the following form.

### Solutions to Problems

[1]

A polyurethane foam decomposition device including:
a container for containing a polyurethane foam and a decomposer;
a pressing part for pressing the polyurethane foam in the container; and
a heating part for heating an inside of the container,
wherein
the container includes a retaining part for retaining a liquid material containing a decomposed material of the polyurethane foam and the decomposer, and
the pressing part is configured to press the polyurethane foam downward to push the polyurethane foam into the liquid material in the retaining part.

### Advantageous Effects of Invention

The present disclosure can obtain a polyol having stable quality.

### BRIEF DESCRIPTION OF DRAWINGS

FIG. 1 is a diagram schematically illustrating a decomposition device according to an embodiment.

FIG. 2 is a diagram illustrating a state in which a polyurethane foam is loaded.

FIG. 3 is a diagram illustrating a state in which a polyurethane foam is pressed.

FIG. 4 is a diagram illustrating a state in which a polyurethane foam is pressed according to another embodiment.

### DESCRIPTION OF EMBODIMENTS

Here, desirable examples of the present disclosure will be described.

[2]

The polyurethane foam decomposition device according to [1], wherein
a discharge port for the liquid material is formed at a position higher than an inner bottom surface of the container, and
a portion of the container lower than a lower end of the discharge port is defined as the retaining part.
   [3]

A polyurethane foam decomposition method including:
loading a polyurethane foam and a decomposer into a container;
heating an inside of the container containing the polyurethane foam and the decomposer;
retaining a liquid material containing a decomposed material of the polyurethane foam and the decomposer in the container; and
pressing the polyurethane foam that has not decomposed downward to push the polyurethane foam that has not decomposed into the liquid material retained.

Hereinafter, the present disclosure will be described in detail. In the present specification, the description using “to” for a numerical range includes the lower limit value and the upper limit value unless otherwise specified. For example, the expression “10 to 20” includes both the lower limit value “10” and the upper limit value “20”. That is, “10 to 20” has the same meaning as “10 or more and 20 or less”.

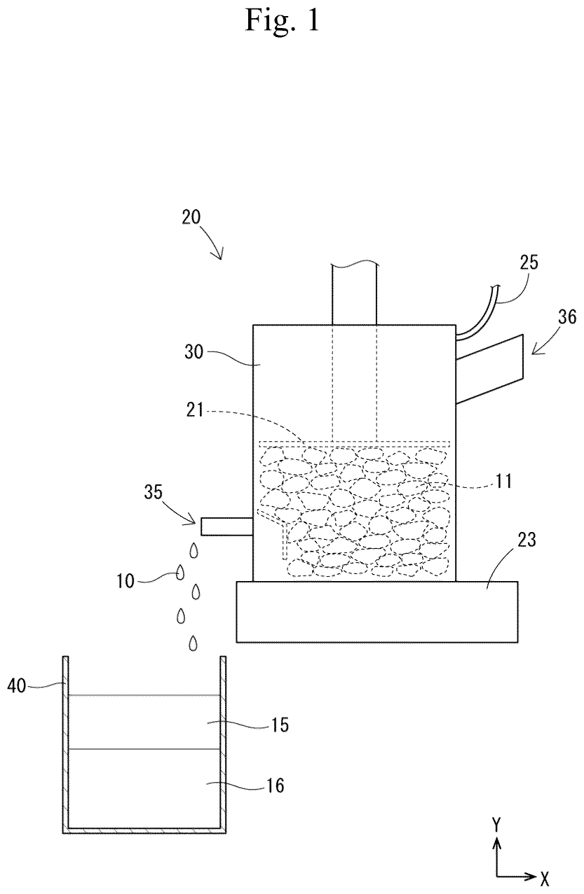

As illustrated in FIGS. 1 to 3, a decomposition device 20 for decomposing a polyurethane foam 11 of the present embodiment includes a container 30 for containing the polyurethane foam 11 and a decomposer 13, a pressing part 21 that presses the polyurethane foam 11 in the container 30, and a heating part 23 that heats the inside of the container 30. The container 30 has a retaining part 31 for retaining a liquid material 10 containing a decomposed material of the polyurethane foam 11 and the decomposer 13. The pressing part 21 is configured to press the polyurethane foam 11 downward to push the polyurethane foam 11 into the liquid material 10 in the retaining part 31. In each drawing, a Y-axis direction is an up-down direction, and an X-axis direction is a direction orthogonal to the Y-axis direction.

The polyurethane foam 11 may be any of a flexible polyurethane foam, a semi-rigid polyurethane foam, and a rigid polyurethane foam. The polyurethane foam 11 may be a polyurethane foam having an open-cell structure or a polyurethane foam having a closed-cell structure. The polyurethane foam 11 may be a pulverized material pulverized to a predetermined size. Examples of the pulverized material of the polyurethane foam 11 include offcuts discharged in the process of producing the polyurethane foam 11 or a pulverized material of the polyurethane foam 11 that has been used and is to be discarded. The pulverized material of the polyurethane foam 11 may be residue or waste of the polyurethane foam 11 discharged in the process of producing the polyurethane foam 11.

The maximum diameter of the polyurethane foam 11 is not particularly limited. The maximum diameter of the polyurethane foam 11 can be, for example, 2 cm or more and 30 cm or less in consideration of ease of loading the polyurethane foam into the container 30 and a decomposition speed.

The decomposer 13 is not particularly limited as long as it chemically decomposes and liquefies a urethane bond, but a compound having a hydroxyl group or an amine compound is preferable from the viewpoint of reactivity and cost.

Examples of the compound having a hydroxyl group include ethylene glycol, diethylene glycol, propylene glycol, dipropylene glycol, tripropylene glycol, trimethylene glycol, 1,4-butanediol, 1,5-pentadiol, 1,6-hexanediol, polyoxyethylene glycol, polyoxypropylene glycol, glycerin, and polyethylene glycol. These compounds having a hydroxyl group can be used alone or as a mixture of two or more thereof. Among these, dipropylene glycol and 1,4-butanediol are suitable.

Examples of the amine compound include ethylenediamine, tetramethylenediamine, hexamethylenediamine, propanediamine, 2-ethylhexylamine, isopropanolamine, 2-(2-aminoethylamino)ethanol, 2-amino-2-hydroxymethyl-1,3-propanediol, ethylaminoethanol, aminobutanol, n-propylamine, di-n-propylamine, n-amylamine, isobutylamine, methyldiethylamine, monoethanolamine, diethanolamine, triethanolamine, cyclohexylamine, piperazine, piperidine, aniline, toluidine, benzylamine, phenylenediamine, tolylenediamine, 4-4′-diphenylmethanediamine, xylylenediamine, chloroaniline, pyridine, picoline, N-methylmorpholine, ethylmorpholine, and pyrazole. These amine compounds can be used alone or as a mixture of two or more thereof. Among these, diethanolamine and triethanolamine are suitable.

The addition amount of the decomposer 13 is preferably 5 parts by mass or more and 30 parts by mass or less, and more preferably 10 parts by mass or more and 20 parts by mass or less with respect to 100 parts by mass of the polyurethane foam.

In the decomposition reaction using the decomposer 13, a decomposition catalyst can be further added as necessary to increase the reaction speed.

As the catalyst to be added, those used in the production of the urethane foam are preferable. Examples thereof include triethylamine, N,N-dimethylcyclohexylamine, N,N,N′,N′-tetramethylethylenediamine, N,N,N′,N′ tetramethylpropane 1,3-diamine, N,N,N′,N′-tetramethylhexane 1,6-diamine, N,N,N′,N″, N″-pentamethyldiethylenetriamine, N,N,N′,N″,N″-pentamethyldipropylenetriamine, tetramethylguanidine, triethylenediamine, N,N′-dimethylpiperazine, N,-methyl, N′-(2-dimethylamino) ethylpiperazine, N-methylmorpholine, N-(N′,N′-dimethylaminoethyl)-morpholine, 1,2-dimethylimidazole, hexamethylenetetramine, dimethylaminoethanol, dimethylaminoethoxyethanol, N,N,N′-trimethylaminoethylethanolamine, N-methyl-N′-(2-hydroxyethyl) piperazine, N-(2-hydroxyethyl) morpholine, bis(2-dimethylaminoethyl)ether, ethylene glycol bis(3-dimethyl)-aminopropyl ether, diazabicycloundecene, stannous octoate, dibutyltin diacetate, dibutyltin dilaurate, dibutyltin mercaptide, dibutyltin thiocarboxylate, dibutyl indimaleate, dioctyltin mercaptide, dioctyltin thiocarboxylate, lead octanoate, zinc octanoate, calcium octanoate, potassium acetate, and potassium octanoate. Among these, triethylenediamine, diazabicycloundecene, potassium acetate, and potassium octanoate are suitable.

The addition amount of the catalyst is more preferably 1 part by mass or more and 30 parts by mass or less, and still more preferably 5 parts by mass or more and 20 parts by mass or less with respect to 100 parts by mass of the decomposer.

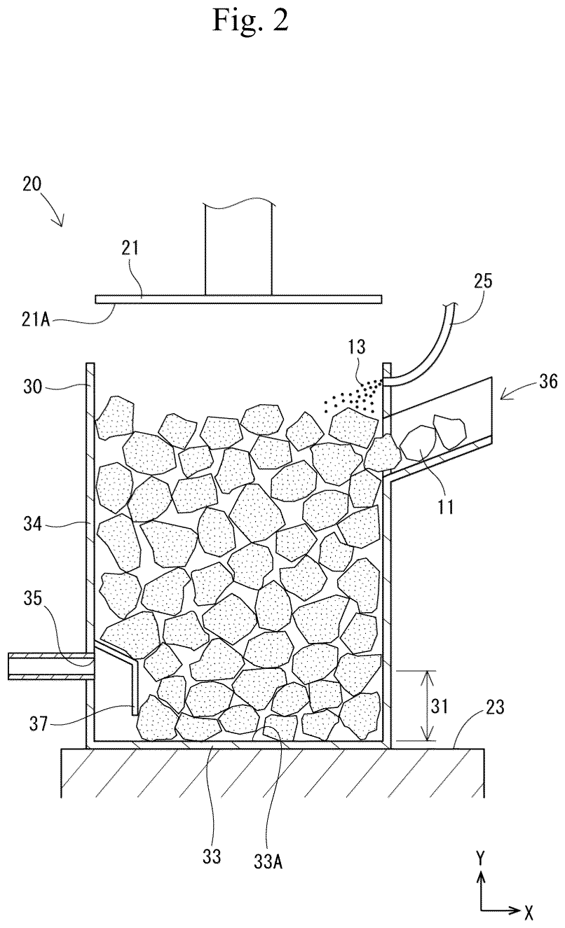

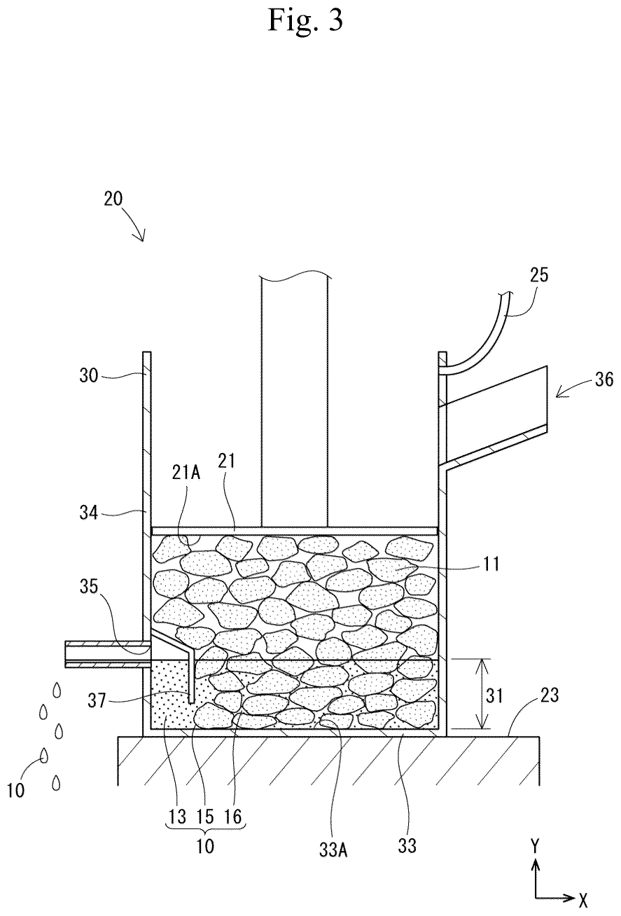

Next, the decomposition device 20 will be described. The decomposition device 20 includes the container 30, the pressing part 21, and the heating part 23. The decomposition device 20 may further include a decomposer charging part 25 for charging the decomposer 13. The decomposer charging part 25 is, for example, not of a system which applies the decomposer 13 to the polyurethane foam 11 in a spray form, but of a system which directly charges the decomposer 13 without atomizing it. In the decomposition device 20 in FIGS. 2 and 3, the decomposer charging part 25 is provided so as to be open above an inlet 36 described later. The decomposer 13 is fed to the decomposer charging part 25 by a pump or the like, and is directly charged into the container 30. In FIGS. 2 and 3, the decomposer 13 is schematically indicated by black circles.

Other configurations of the container 30 are not particularly limited as long as the container can contain the polyurethane foam 11 and the decomposer 13. For example, the container 30 includes a bottom wall 33 and a side wall 34 rising from the periphery of the bottom wall 33. The bottom wall 33 has a flat plate shape such as a circular shape or a rectangular shape. The side wall 34 has a cylindrical shape such as a circular cylinder or a rectangular cylinder. Considering the heating efficiency and the loading frequency of the polyurethane foam 11, the height of the container 30, when the bottom wall 33 has a circular shape, is preferably 1 time or more and 5 times or less the diameter of the bottom wall 33, and when the bottom wall 33 has a rectangular shape, the height of the container 30 is preferably 1 time or more and 5 times or less the length of a diagonal line of the bottom wall 33.

The container 30 has the retaining part 31 for retaining the liquid material 10 containing the decomposed material of the polyurethane foam 11 and the decomposer 13. Other configurations of the retaining part 31 are not particularly limited as long as the liquid material 10 can be retained. For example, the retaining part 31 can be constituted by a portion from an inner bottom surface 33A of the container 30 to a predetermined height of the container 30. The predetermined height of the container 30 can be set to a height of 1/10 or more and ½ or less of the height of the container 30. In FIGS. 2 and 3, the range of the retaining part 31 is indicated by an arrow. The polyurethane foam 11 that has not decomposed can be contained above the retaining part 31 in the container 30. In the present disclosure, the polyurethane foam 11 that has not decomposed includes the polyurethane foam 11 in the middle of decomposition which has partially decomposed and in a solid state. The polyurethane foam 11 that has not decomposed may be present also in the retaining part 31.

In the present embodiment, a discharge port 35 for the liquid material 10 is formed at a position higher than the inner bottom surface 33A of the container 30, and a portion of the container 30 lower than the lower end of the discharge port 35 is defined as the retaining part 31. The configuration of the discharge port 35 is not particularly limited. The discharge port 35 is open to the side wall 34 of the container 30, for example. The discharge port 35 of the present embodiment has a simple configuration without an opening/closing mechanism and the like, and is always open. As illustrated in FIG. 3, when the liquid level of the liquid material 10 in the container 30 reaches the lower end of the discharge port 35, the excess liquid material 10 flows out from the discharge port 35. That is, the amount of the liquid material 10 in the container 30 can be adjusted by adjusting the lower end position of the discharge port 35. Considering the decomposition efficiency, the lower end position of the discharge port 35 is preferably lower than the position of ½ of the height of the container 30, and is more preferably at a position where the container 30 can be heated to 150° C. or more by the heating part 23.

In the container 30, the inlet 36 for loading the polyurethane foam 11 is formed at a position higher than the retaining part 31. The inlet 36 of the present embodiment is also an inlet for charging the decomposer 13. The container 30 of the present embodiment can be filled with the polyurethane foam 11 that has not decomposed above the retaining part 31. The polyurethane foam 11 positioned above the retaining part 31 covers the retaining part 31, which can exhibit an action of preventing the heat in the retaining part 31 from escaping upward or an action of retaining the gas generated in the retaining part 31 within the container 30.

The container 30 may have a restriction part 37 which restricts the polyurethane foam 11 that has not decomposed from flowing out from the discharge port 35. The restriction part 37 can also serve functions such as preventing the polyurethane foam 11 that has not decomposed from covering and closing the discharge port 35, and preventing the discharge port 35 from being clogged with the polyurethane foam 11 that has not decomposed. As illustrated in FIG. 3, the restriction part 37 of the present embodiment covers the discharge port 35 from the retaining part 31 side so as to narrow the path of the polyurethane foam 11 that has not decomposed from the retaining part 31 toward the discharge port 35.

The pressing part 21 presses the polyurethane foam 11 in the container 30. The pressing part 21 presses the polyurethane foam 11 downward to push the polyurethane foam 11 into the liquid material 10 in the retaining part 31. Other configurations of the pressing part 21 are not particularly limited. For example, the pressing part 21 has a pressing surface 21A having a planer shape that presses the polyurethane foam 11. Preferably, the pressing part 21 is configured to compress the polyurethane foam 11 between the pressing surface 21A and the inner bottom surface 33A of the container 30. With this configuration, the polyurethane foam 11 can be uniformly compressed between the pressing surface 21A and the inner bottom surface 33A of the container 30, and a difference in the progress of the decomposition of the polyurethane foam 11 due to a difference in the degree of compression and heating is less likely to occur.

The pressing part 21 applies a downward force to the polyurethane foam 11 without applying a shearing force. The phrase “without applying a shearing force” means that no shear force applied during extrusion by an extruder is applied. Examples of the means of applying a force without applying a shearing force include a means of applying a force such that the polyurethane foam 11 in a solid form is not broken but compressed in one direction. Specifically, a means of moving the pressing surface 21A downward using a power cylinder is exemplified. The pressing part 21 is configured to be movable in up-down directions such that the pressing surface 21A does not come to a position lower than the lower end of the discharge port 35.

The compressive stress by the pressing part 21 is not particularly limited. The compressive stress by the pressing part 21 may have any magnitude as long as it can sufficiently press the polyurethane foam 11. For example, in the case of a flexible polyurethane foam, the compressive stress can be 5 kPa or more and 15 kPa or less.

The heating part 23 heats the inside of the container 30. The heating part 23 is preferably provided in contact with a portion below the position of ½ of the height of the container 30. For example, the heating part 23 includes a heater (heat generation source) and is provided in contact with the lower surface of the bottom wall of the container 30. On the other hand, the heating part 23 is not provided at the portion where the inlet 36 is provided (upper portion of the container 30). In the decomposition treatment of the polyurethane foam 11, it is preferable not to heat the polyurethane foam 11 above the retaining part 31, particularly in the vicinity of the inlet 36. That is, the container 30 is preferably configured such that the decomposition reaction is mainly performed in the lower portion (retaining part 31 side), and the polyurethane foam 11 is stored in the upper portion (inlet 36 side). With the above-described configuration, it is possible to suppress the decomposition reaction of the polyurethane foam 11 on the inlet 36 side while promoting the decomposition reaction of the polyurethane foam 11 on the discharge port 35 side in the container 30. For example, the decomposition reaction of the polyurethane foam by the decomposer 13 hardly proceeds under conditions of non-heating (for example, 50° C. or less) and less than 10 hours. Thus, it is possible to prevent the decomposition reaction of the polyurethane foam 11 from unintentionally proceeding at the time of loading the polyurethane foam 11, and the decomposed material from adhering to the periphery of the inlet 36, the pressing part 21, and the like. To obtain a decomposed material having stable quality in the decomposition of the polyurethane foam 11, it is effective to clean the decomposition device 20 for each type of the polyurethane foam 11 to be treated. As described above, the heating portion and the non-heating portion are separated in the container 30, whereby the adhesion of the decomposed material can be reduced, and the container 30 can be easily cleaned. In addition, during the decomposition reaction of the polyurethane foam 11, a portion where the polyurethane foam 11 is not present is not heated unnecessarily, whereby energy efficiency during heating can be improved.

Next, an example of a method for decomposing the polyurethane foam 11 will be described with reference to FIGS. 2 and 3. The method for decomposing the polyurethane foam 11 includes loading the polyurethane foam 11 and the decomposer 13 into the container 30, heating the inside of the container 30 containing the polyurethane foam 11 and the decomposer 13, retaining the liquid material 10 containing a decomposed material of the polyurethane foam 11 and the decomposer 13 in the container 30, and pressing the polyurethane foam 11 that has not decomposed downward to push the polyurethane foam 11 that has not decomposed into the liquid material 10 retained.

In the method for decomposing the polyurethane foam 11, a mode of loading the polyurethane foam 11 and the decomposer 13 is not particularly limited. For example, when loading the polyurethane foam 11 and the decomposer 13, an appropriate amount of the decomposer 13 is charged from the decomposer charging part 25 according to the loading amount of the polyurethane foam 11. Further, an extra amount of the decomposer 13 may be placed in the retaining part 31 before starting the decomposition treatment, and thereafter, an appropriate amount of the decomposer 13 may be charged from the decomposer charging part 25 according to the loading amount of the polyurethane foam 11. In this manner, the liquid material 10 containing a sufficient amount of the decomposer 13 can be retained in the retaining part 31 from the initial stage of the decomposition treatment. Further, from the viewpoint of convenience, the decomposer 13 may be preferably directly charged into the container 30 without applying the decomposer 13 to the polyurethane foam 11 in advance. Further, since the polyurethane foam 11 and the decomposer 13 can be sufficiently brought into contact with each other in the liquid material 10, it is not necessary to load the polyurethane foam 11 and the decomposer 13 simultaneously.

The inside of the container 30 containing the polyurethane foam 11 and the decomposer 13 can be heated by the heating part 23. The heating temperature in the container 30 is not particularly limited. The heating temperature in the container 30 is preferably 150° C. or more and 250° C. or less, and more preferably 170° C. or more and 230° C. or less. The heating temperature in the container 30 is the temperature of the highest temperature portion in the container 30. In the present embodiment, a set temperature of the heating part 23 may be regarded as the heating temperature in the container 30. When a portion where the polyurethane foam 11 and the decomposer 13 are in contact with each other in the container 30 is heated, the polyurethane foam 11 decomposes and a decomposed material in a liquid form is produced. The decomposed material in a liquid form contains a polyol 15 derived from a raw material polyol of the polyurethane foam 11, an amine component 16 derived from a raw material isocyanate, and the like. The decomposed material in a liquid form flows downward and stays in the retaining part 31 together with the decomposer 13.

In the method for decomposing the polyurethane foam 11, the polyurethane foam 11 that has not decomposed is pressed downward by the pressing part 21 and pushed into the liquid material 10 retained. The polyurethane foam 11 that has not decomposed pushed into the liquid material is brought into contact with the decomposer 13 in the liquid material 10 and heated. Then, the polyurethane foam 11 decomposes, and a decomposed material in a liquid form is further produced. When the decomposition of the polyurethane foam 11 proceeds and the liquid level of the liquid material 10 reaches the lower end of the discharge port 35, the liquid material 10 is discharged from the discharge port 35. The discharged liquid material 10 is appropriately collected. For example, a collection container 40 is disposed below the discharge port 35, and the decomposed material flowing down from the discharge port 35 is collected into the collection container 40. From the collected decomposed material, the polyol 15 can be purified by a known method to obtain a regenerated polyol 15. In addition to the polyol 15, various components may be purified from the collected decomposed material to obtain regenerated raw materials.

Next, operational effects of the present embodiment will be described. In the decomposition device 20 and the decomposition method for the polyurethane foam 11 of the present embodiment, the polyurethane foam 11 is pressed downward and pushed into the liquid material 10 in the retaining part 31. This makes it possible to bring the decomposer 13 and the polyurethane foam 11 into contact with each other in the liquid material 10. Thus, for example, even without uniformly applying the decomposer 13 to the surface of the polyurethane foam 11 or even without simultaneously loading the polyurethane foam 11 and the decomposer 13 at a predetermined ratio, the contact efficiency between the polyurethane foam 11 and the decomposer 13 can be improved. In addition, heat can be transferred to the polyurethane foam 11 via the liquid material 10, and thus the heating efficiency of the polyurethane foam 11 can be improved as compared with a case where heat is transferred to the polyurethane foam 11 via air, for example. Further, in some types of the polyol 15 and the amine component 16 contained in the liquid material 10, the produced polyol 15 and/or amine component 16 itself may act as the decomposer 13 and contribute to the decomposition of the polyurethane foam 11. The polyurethane foam 11 can thus be sufficiently decomposed, and a decomposed material having stable quality can be obtained.

Conventionally, an extruder or a kneader that has been frequently used for the decomposition of the polyurethane foam 11 is relatively expensive as a device itself, and removal of the decomposed material in the device has been complicated. On the other hand, the decomposition device 20 of the present embodiment can be configured to be less expensive and simpler than the extruder or the kneader, and the decomposed material in the device can be easily removed. Further, in the decomposition device 20 of the present embodiment, the polyurethane foam 11 that has not decomposed is less likely to be discharged as compared with a configuration like an extruder in which its contents are forcibly extruded. Thus, a decomposed material having stable quality can be obtained.

In the decomposition device 20 of the present embodiment, the discharge port 35 for the liquid material 10 is formed at a position higher than the inner bottom surface 33A of the container 30, and a portion of the container 30 lower than the lower end of the discharge port 35 is defined as the retaining part 31. This configuration makes it possible to form the retaining part 31 in a simple configuration. In addition, the decomposed material of the polyurethane foam 11 can be successively discharged from the discharge port 35, which does not require time and effort to match the progress (end point) of the reaction with the timing of discharge. Further, as compared with the configuration in which the discharge port is formed at the bottom of the container, the polyurethane foam 11 that has not decomposed is less likely to be pushed into the discharge port 35. Thus, the discharge port 35 is less likely to be clogged with the polyurethane foam 11 that has not decomposed.

### <Other Embodiments>

The present disclosure is not limited to the embodiment described with reference to the above description and drawings, and for example, the following embodiments are also included in the technical scope of the present disclosure.

(1) The retaining part is not limited to a configuration in which a portion of the container lower than the lower end of the discharge port constitutes the retaining part. For example, an opening/closing mechanism such as a valve may be provided at the discharge port, and the valve may be closed to constitute a retaining part for retaining the liquid material. In this case, the valve may be opened as necessary to discharge an excess liquid material.

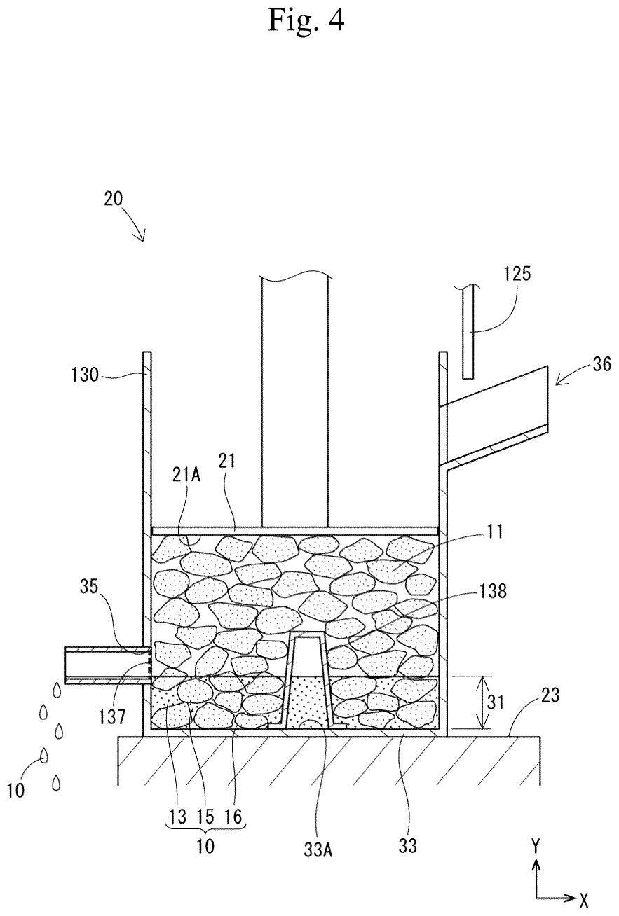

(2) The pressing part may be a means for applying a load to the polyurethane foam using a weight or the like, other than means such as a hydraulic cylinder. Further, as in a container 130 in FIG. 4, a spacer 138 that defines the position where the pressing surface 21A of the pressing part 21 is lowered may be provided.

(3) As in the container 130 in FIG. 4, a restriction part 137 that restricts undecomposed polyurethane foam from flowing out from the discharge port 35 may be constituted by a screen. The screen only needs to be configured to allow the liquid material to pass therethrough but not to allow the undecomposed polyurethane foam to pass therethrough. Instead of providing a restriction part, diameter of the discharge port may be made smaller than that of the polyurethane foam to restrict the discharge of undecomposed polyurethane foam.

(4) The shape of the container can be appropriately changed. For example, the bottom wall is not limited to a flat plate shape, but protrusions or recesses may be provided to increase heat transfer. In addition, as in the container 130 in FIG. 4, a decomposer charging part 125 may be configured such that the decomposer 13 is charged from the inlet 36.

(5) As the heating part, a heat generation source such as a ribbon heater may be further provided in contact with the side wall.

The present disclosure is not limited to the embodiments described in detail above, and various modifications or changes can be made.

### REFERENCE SIGNS LIST

10 . . . liquid material
11 . . . polyurethane foam
13 . . . decomposer
15 . . . polyol
16 . . . amine component
20 . . . decomposition device
21 . . . pressing part
21A . . . pressing surface
23 . . . heating part
25, 125 . . . decomposer charging part
30, 130 . . . container
31 . . . retaining part
33 . . . bottom wall
33A . . . inner bottom surface
34 . . . side wall
35 . . . discharge port
36 . . . inlet
37 . . . restriction part
40 . . . collection container
138 . . . spacer

1. A polyurethane foam decomposition device comprising:
a container for containing a polyurethane foam and a decomposer;
a pressing part for pressing the polyurethane foam in the container; and
a heating part for heating an inside of the container,
wherein
the container includes a retaining part for retaining a liquid material containing a decomposed material of the polyurethane foam and the decomposer, and
the pressing part is configured to press the polyurethane foam downward to push the polyurethane foam into the liquid material in the retaining part.

2. The polyurethane foam decomposition device according to claim 1, wherein
a discharge port for the liquid material is formed at a position higher than an inner bottom surface of the container, and
a portion of the container lower than a lower end of the discharge port is defined as the retaining part.

3. A polyurethane foam decomposition method comprising:
loading a polyurethane foam and a decomposer into a container;
heating an inside of the container containing the polyurethane foam and the decomposer;
retaining a liquid material containing a decomposed material of the polyurethane foam and the decomposer in the container; and
pressing the polyurethane foam that has not decomposed downward to push the polyurethane foam that has not decomposed into the liquid material retained.
